(19) United States
(12) Patent Application Publication
(10) Pub. No.: US 2025/0264705 A1
(43) Pub. Date: Aug. 21, 2025

(54) OPTICAL DEVICE FOR A SEMICONDUCTOR LASER AND LASER DEVICE COMPRISING SUCH AN OPTICAL DEVICE

(71) Applicant: LIMO GMBH, Dortmund (DE)

(72) Inventors: Dirk Hauschild, Dormagen (DE); Janis Sils, Dortmund (DE)

(21) Appl. No.: 18/856,865

(22) PCT Filed: Dec. 8, 2022
(86) PCT No.: PCT/EP2022/084907

§ 371 Date: Oct. 14, 2024

(30) Foreign Application Priority Data
Apr. 22, 2022 (DE) 102022109732.3

(51) Int. Cl. G02B 19/00; G02B 3/00; G02B 3/04

(52) U.S. Cl. CPC G02B 19/0052; G02B 3/04; G02B 2003/0093

(57) ABSTRACT

The invention relates to an optical device (12) for a semiconductor laser (10), more particularly for a single-emitter semiconductor laser, comprising a fast-axis collimation lens (13), wherein the optical device (12) is designed such that the laser radiation (11) emitted from the semiconductor laser (10) passes through the fast-axis collimation lens (13), and a slow-axis collimation lens (14) having an entry surface (15) and an exit surface (16), wherein the optical device (12) is designed such that the laser radiation (11) passing through the fast-axis collimation lens (13) enters the slow-axis collimation lens (14) through the entry surface (15) and exits the slow-axis collimation lens (15) through the exit surface (16), wherein the entry surface (15) is concave at least in regions and wherein the exit surface (16) is convex at least in regions.

According to the preamble of claim 1, the present invention relates to an optical device for a semiconductor laser, in particular for a single-emitter semiconductor laser, and to a laser device with such an optical device.

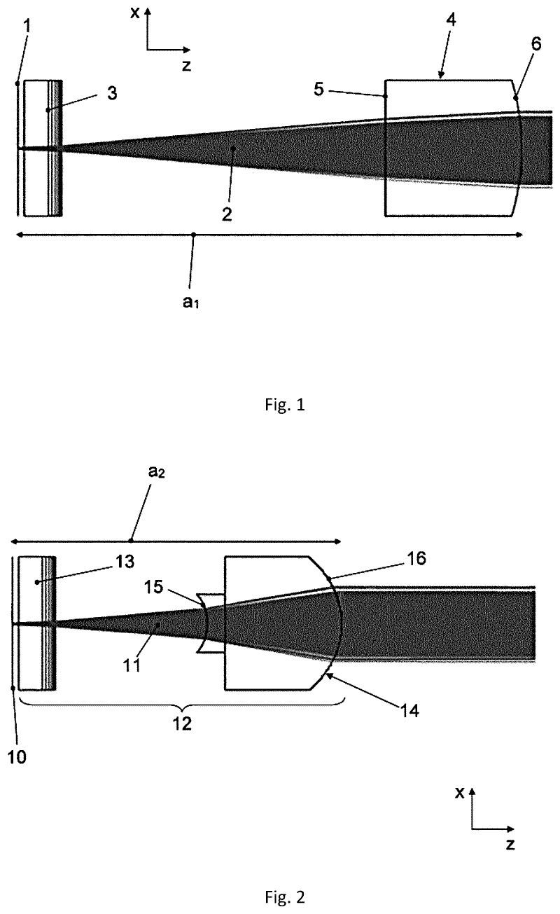

Optical devices and laser devices of the aforementioned type are known. FIG. 1 shows an example of such a laser device with such an optical device. The laser device according to FIG. 1 comprises a single-emitter semiconductor laser 1, which has an exiting surface from which laser radiation 2 emerges. The laser radiation 2 propagating in the z direction has different divergences in a first direction x and a second direction y, whereby the first direction x corresponds to the slow-axis direction of the laser radiation 2 and where the second direction y is in the plane of the drawing FIG. 1 extends into it and corresponds to the fast-axis direction of the laser radiation 2. The divergence in the fast axis direction is significantly greater than in the slow axis direction.

The optical device according to FIG. 1 comprises a fast-axis collimating lens 3, which is designed as a cylindrical lens, the cylinder axis of which extends in the first direction x. 1 further comprises a slow-axis collimating lens 4 with an entering surface 5 and an exiting surface 6. The entering surface 5 is flat and the exiting surface 6 is designed as a convex cylindrical lens, the cylinder axis of which extends in the second direction y. The fast-axis collimating lens 3 significantly reduces the divergence of the laser radiation 2 with respect to the fast-axis direction or the laser radiation 2 with respect to the fast-axis direction largely collimated. The slow-axis collimating lens 4 significantly reduces the divergence of the laser radiation 2 with respect to the slow-axis direction or the laser radiation 2 is largely collimated with respect to the slow-axis direction.

The large distance ai between the exiting surface of the semiconductor laser 1 and the exiting surface 6 of the slow-axis collimating lens 4 proves to be disadvantageous in such an optical device or in such a laser device. In the prior art, this distance ai is between 10 mm and 20 mm. If several of these laser devices are to be combined in one housing, there is a lot of unused space in the housing due to the large distance.

Based on this prior art, the present invention has the task of creating an optical device and a laser device of the type mentioned at the outset, which require less installation space.

This is achieved according to the invention by an optical device of the type mentioned at the outset with the characterizing features of claim 1 and by a laser device of the type mentioned at the outset with the features of claim 10. The subclaims relate to preferred embodiments of the invention.

According to claim 1 it is provided that the entering surface is at least partially concave and that the exiting surface is at least partially convex. With such a design, the distance between the exiting surface of the semiconductor laser and the exiting surface of the slow-axis collimating lens can be significantly reduced. For example, the distance between the exiting surface of the semiconductor laser and the exiting surface of the slow-axis collimating lens can be between 3 mm and 15—mm, in particular between 5 mm and 11 mm, preferably between 7 mm and 8 mm. This results in less unused space in the housing when combining several laser devices in one housing.

It can be provided that the slow-axis collimating lens comprises a transparent substrate on which both the entering surface and the exiting surface are formed, in particular where the slow-axis collimating lens is a monolithic component. This makes the optical device comparatively compact and robust.

It can be provided that the extent of the entering surface or the concave section of the entering surface in a first direction, which corresponds to the slow axis direction of the laser radiation emitted by the semiconductor laser, is smaller than the extent of the exiting surface or the convex section the exiting surface in the first direction, in particular wherein the extent of the entering surface or the concave portion of the entering surface in the first direction is between 0.3 and 0.7 times as large as the extent of the exiting surface or the convex portion of the exiting surface in the first direction is.

There is the possibility that the effective focal length of the slow-axis collimating lens formed by the entering surface and the exiting surface is between 5 mm and 50 mm, in particular between 10 mm and 30 mm, preferably between 13 mm and 20 mm, for example approximately is 15 mm tall. The advantage of the optical device according to the invention is that despite a very small distance between the exiting surface of the semiconductor laser and the exiting surface of the slow-axis collimating lens of, for example, 7 mm to 8 mm, a comparatively large effective focal length of, for example, approximately 15 mm can be maintained.—This is achieved by the concave entering surface, which expands the laser radiation striking it before the laser radiation is largely collimated by the convex exiting surface.

It can be provided that the fast-axis collation lens is designed as a cylindrical lens, the cylinder axis of which extends in the first direction.

It can be provided that both the entering surface and the exiting surface of the slow-axis collimating lens are designed as cylindrical lenses, with the cylinder axes of the entering surface and the exiting surface being parallel to one another, in particular with the cylinder axes extending in a second direction, which is perpendicular to the first direction and corresponds to the fast axis direction of the laser radiation emanating from the semiconductor laser.

It can further be provided that the cross section of the cylindrical geometry of the entering surface and/or the cross section of the cylindrical geometry of the exiting surface deviates from a circular shape, in particular wherein the cylindrical lens forming the entering surface and/or the cylindrical lens forming the exiting surface have an aspherical surface shape.

The deviation from a circular shape of the cross section of the cylindrical geometry of the entering surface can be different from the deviation from a circular shape of the cross section of the cylindrical geometry of the exiting surface.

It is possible that the optical device is set up to produce an intensity distribution that deviates from a homogeneous intensity distribution in the form of the aspherical surface shapes of the entering surface and/or the exiting surface--To generate laser radiation emerging from the exiting surface. This allows the light distribution in the collimated laser radiation to be influenced by targeted adjustment of the aspherical surface shapes. Compared to the prior art, the distribution can be improved so that it is also advantageous for applications other than collimation. For example, fiber coupling of laser radiation can be achieved with greater efficiency by concentrating the energy in the center of the fiber core. In addition, the arrangement of two cylindrical lenses in one optical component offers the possibility of beam shaping with a constant number of surfaces in the beam path.

According to claim 10, the laser device comprises a semiconductor laser, in particular a single-emitter semiconductor laser, and an optical device according to the invention.

Further features and advantages of exemplary embodiments of the invention are described below with reference to the drawings. The same reference numbers are used for the same or similar parts and for parts with the same or similar functions. Show it:

FIG. 1 shows a schematic side view of a laser device according to the prior art;

FIG. 2 is a schematic side view of a laser device according to the invention.

Cartesian coordinate systems are shown in the figures. The y-direction extends into the drawing plane of the figures.

It is not necessary for a device according to the invention to have all of the features described below. It is also possible for a device according to the invention to have only individual features of the exemplary embodiments described below.

The laser device according to FIG. 2 comprises a semiconductor laser 10, in particular a single-emitter semiconductor laser, which has an exiting surface from which laser radiation 11 emerges. The laser radiation 11 propagating in the z direction has different divergences in a first direction x and a second direction y, whereby the first direction x corresponds to the slow-axis direction of the laser radiation 11 and where the second direction y is in the 2 and corresponds to the fast-axis direction of the laser radiation 2. The divergence in the fast axis direction is significantly greater than in the slow axis direction.--2 further comprises an optical device 12 according to the invention. This optical device 12 comprises a fast-axis collimating lens 13, which is designed as a cylindrical lens, the cylindrical axis of which extends in the first direction x. The optical device 12 further comprises a slow-axis collimating lens 14 with an entering surface 15 and an exiting surface 16. The entering surface 15 is designed as a concave cylindrical lens and the exiting surface 16 is designed as a convex cylindrical lens, the cylinder axes of these cylindrical lenses being in the second direction y extend.

The fast-axis collimating lens 13 significantly reduces the divergence of the laser radiation 11 with respect to the fast-axis direction or the laser radiation 11 is largely collimated with respect to the fast-axis direction. The slow-axis collimating lens 4 significantly reduces the divergence of the laser radiation 11 with respect to the slow-axis direction or the laser radiation 11 is largely collimated with respect to the slow-axis direction.

The concave entering surface 15 is only approximately half as extensive in the x direction as the exiting surface 16. It is possible instead to choose the expansion of the entering surface 15 in the x direction to be exactly as large as the expansion of the exiting surface 16 in x-Direction. However, it would then be sufficient to provide only a central section with a concave curvature because the beam diameter of the laser radiation 11 is comparatively small when it hits the entering surface 15.

The slow-axis collimating lens 14 is a monolithic optical component on which the entering surface 15 and the exiting surface 16 are formed.—The entering surface 15 and the exiting surface 16 each have a cross section of the cylinder geometry that deviates from a circular shape, in particular the cylindrical lens forming the entering surface 15 and the cylindrical lens forming the exiting surface 16 have an aspherical surface shape. The deviation from a circular shape of the cross section of the cylindrical geometry of the entering surface 15 can be different from the deviation from a circular shape of the cross section of the cylindrical geometry of the exiting surface 16.

The distance a2 between the exiting surface of the semiconductor laser 1 and the exiting surface 6 of the slow-axis collimating lens 4 is between 7 mm and 8 mm.

1. Optical device for a semiconductor laser, in particular for a single-emitter semiconductor laser, comprising
a fast-axis collimating lens, wherein the optical device is designed so that the laser radiation emitted by the semiconductor laser passes through the fast-axis collimating lens;
a slow-axis collimating lens with an first entrance surface and an first exit surface, wherein the optical device is designed so that the laser radiation passed through the fast-axis collimating lens enters the slow-axis collimating lens through the first entrance surface and exits the slow-axis collimating lens through the first exit surface,
characterized in that the first entrance surface is at least partially concave shaped and the first exit surface is at least partially convex shaped.

2. Optical device according to claim 1, characterized in that the slow-axis collimating lens comprises a transparent substrate on which both the first entrance surface and the first exit surface are formed, in particular, wherein the slow-axis collimating lens is a monolithic component.

3. Optical device according to claim 1, characterized in that the size of the first entrance surface or its concave portion in the first direction is smaller than that of the first exit surface or its convex portion typically between 0.3 and 0.7 times the size, the first direction corresponds to the slow-axis direction of the laser radiation emitted by the semiconductor laser.

4. Optical device according to claim 1, characterized in that the effective focal length of the slow-axis collimating lens is between 5 mm and 50 mm, in particular between 10 mm and 30 mm, preferably between 13 mm and 20 mm, more preferably about 15 mm.

5. Optical device according to claim 1, characterized in that the fast-axis collimating lens is designed as a cylindrical lens, the cylinder axis of which extends in the first direction.

6. Optical device according to claim 1, characterized in that both the first entrance surface and the first exit surface are designed as cylindrical lenses with their cylinder axes parallel to each other, in particular the cylinder axes extending in a second direction which is perpendicular to the first direction and corresponds to the fast-axis direction of the laser radiation emitted by the semiconductor laser.

7. Optical device according to claim 6, characterized in that the cross section of the cylindrical geometry of the first entrance surface and/or the first exit surface deviates from a circular shape, in particular wherein the cylindrical lens forming the first entrance surface and/or the first exit surface has an aspherical surface shape.

8. Optical device according to claim 7, characterized in that the deviation of the first entrance surface from a circular cross-section differs from that of the first exit surface.

9. Optical device according to claim 7, characterized in that the optical device is designed to generate a non-uniform intensity distribution in the laser radiation emerging from the first exit surface, due to the aspherical surface shapes of the first entrance surface and/or the first exit surface.

10. Laser device, comprising a semiconductor laser, in particular a single-emitter semiconductor laser, and an optical device according to claim 1.

11. Laser device according to claim 10, characterized in that the semiconductor laser has an Alpha exit surface for the laser radiation generated by the semiconductor laser, wherein the first distance between the Alpha exit surface and the first exit surface of the slow-axis collimating lens is between 3 mm and 15 mm, in particular between 5 mm and 11 mm, preferably between 7 mm and is 8 mm.
